(19) United States
(12) Patent Application Publication
(10) Pub. No.: US 2018/0126599 A1
(43) Pub. Date: May 10, 2018

(54) RESIN IMPREGNATION APPARATUS AND METHOD OF MANUFACTURING RESIN-IMPREGNATED REINFORCING FIBER USING THE SAME

(71) Applicants: HYUNDAI MOTOR COMPANY, Seoul (KR); KIA MOTORS CORPORATION, Seoul (KR); ILJIN COMPOSITES CO., LTD., Wanju_Gun (KR)

(72) Inventors: Sang Yoon PARK, Daejeon (KR); Sang Jae YOON, Daejeon (KR); Chi Hoon CHOI, Suwon-si (KR); Seok Bong HEO, Jeonju-si (KR); Jae Choon LIM, Yangsan-si (KR)

(73) Assignees: HYUNDAI MOTOR COMPANY, Seoul (KR); KIA MOTORS CORPORATION, Seoul (KR); ILJIN COMPOSITES CO., LTD., Wanju_Gun (KR)

(21) Appl. No.: 15/648,145

(22) Filed: Jul. 12, 2017

(30) Foreign Application Priority Data
Nov. 7, 2016 (KR) 10-2016-0147698

(51) Int. Cl. B29B 11/16; B29C 43/24

(52) U.S. Cl. CPC B29B 11/16; B29C 70/32; B29C 43/245

(57) ABSTRACT

Disclosed is a resin impregnation apparatus. The apparatus includes: a resin supply unit for supplying a resin having a predetermined viscosity downwards; a film formation unit provided at a lower side of the resin supply unit and configured to form the resin supplied from the resin supply unit into a film shape while the resin passes between a pair of rollers spaced apart from each other. The apparatus further includes a fiber supply unit for unwinding a reinforcing fiber and bringing the reinforcing fiber into contact with the film-shaped resin so that the resin is impregnated into the reinforcing fiber to form a resin-impregnated reinforcing fiber.

### CROSS REFERENCE TO RELATED APPLICATION

The present application claims priority to Korean Patent Application No. 10-2016-0147698, filed Nov. 7, 2016, the entire contents of which is incorporated herein for all purposes by this reference.

### BACKGROUND

### Field

The present invention relates generally to a resin impregnation apparatus for filament winding process, in which a resin is impregnated into a reinforcing fiber by being formed into a film-shaped resin and by being brought into contact with the reinforcing fiber, whereby impregnation and interfacial adhesion between the resin and the reinforcing fiber can be improved.

### Description of the Related Art

With reference to FIGS. 1 and 2, a control the resin content includes a drum-type in which a reinforcing fiber 20 passes over a drum 1 coated with a resin 10 to be impregnated with the resin 10, and a fiber-dip type in which the reinforcing fiber 20 passes through a container 20 having the resin 10 therein to be impregnated with the resin 10.

In the case of the drum-type, when used for a long time, it is difficult to control the resin content 10 impregnated into the reinforcing fiber 20 due to gelation of the resin 10. In the case of the fiber-dip type, if the reinforcing fiber 20 passes the container without being dipped therein, reinforcing fiber that is not impregnated with resin is formed, so it is difficult to control the resin content 10 impregnated into the reinforcing fiber 20.

Such difficulty in controlling the amount of the resin 10 impregnated into the reinforcing fiber 20 may lead to uneven impregnation of the resin 10, thereby causing deterioration in quality of manufactured products such as occurrence of a region with excessive resin, generation of voids, exfoliation of resin, etc.

In addition, both of the above-mentioned apparatuses are problematic in that as the resin 10 flows, there occurs loss of a raw material resulting in an increase in an industrial waste. Furthermore, by adapting a fully-open type container 2 for containing the resin therein, a large amount of volatile organic compounds (VOC) such as acetone, toluene, benzene and the like are generated from the resin 10.

The foregoing is intended merely to aid in the understanding of the background of the present invention, and is not intended to mean that the present invention falls within the purview of the related art that is already known to those skilled in the art.

The disclosure of this section is to provide background of the invention. Applicant notes that this section may contain information available before this application. However, by providing this section, Applicant does not admit that any information contained in this section constitutes prior art.

### SUMMARY

An aspect of the present invention is to propose a resin impregnation apparatus for filament winding process, in which a resin is impregnated into a reinforcing fiber by being formed into a film-shaped resin and by being brought into contact with the reinforcing fiber, whereby impregnation and interfacial adhesion between the resin and the reinforcing fiber can be improved.

According to one aspect of the present invention, there is provided a resin impregnation apparatus, including: a resin supply unit supplying a resin having a predetermined viscosity downwards; a film formation unit provided at a lower side of the resin supply unit, configured to form the resin supplied from the resin supply unit into a film shape while the resin passes between a pair of rollers spaced apart from each other; and a fiber supply unit unwinding a reinforcing fiber and bringing the reinforcing fiber into contact with the film-shaped resin so that the resin is impregnated into the reinforcing fiber, and winding the resin-impregnated reinforcing fiber.

The resin supply unit may include: a chamber part containing the resin in an inner space thereof and having an outlet at a lower portion thereof; a mixing part having a flow path communicating with the outlet of the chamber part, at a first end thereof so that the resin moves downwards, and having a screw installed inside the flow path; and a supply part communicating with a second end of the mixing part, and supplying the resin to the film formation unit.

The chamber part may be provided such that a high pressure is formed in the inner space thereof so as to remove bubbles and entrapped air/volatiles present in the resin, and the mixing part may be provided such that the resin from which bubbles are removed by operation of the screw is maintained at the predetermined viscosity.

The film formation unit may include: an accommodation part provided at a lower side of the resin supply unit, and having an opening open upward and a containing space communicating with the opening such that the resin supplied from the resin supply unit is received in the accommodation part, the accommodation part being open at a side thereof to discharge the resin; a first roller provided at a side of the accommodation part to divide the accommodation part; and a second roller provided above the first roller at a location spaced apart from the first roller so that the film-shaped resin is discharged therefrom.

A rotating shaft of the first roller may be placed to be parallel to the ground surface, and a rotating shaft of the second roller may be placed to be parallel to the rotating shaft of the first roller, wherein the rotating shaft of the second roller may be movable up and down so that a distance between the first and second rollers can be adjusted, and the resin passing between the first and second rollers may be formed into the film-shaped resin having a thickness corresponding to the distance between the first and second rollers.

When a liquid surface level of the resin contained in the accommodation part reaches a height of a gap defined by the distance between the first and second rollers, the film-shaped resin may be discharged from the first and second rollers that rotate in opposite directions to each other.

The first and second rollers may be provided with a heating means such that the resin passing between the first and second rollers spaced apart from each other is maintained at the predetermined viscosity.

The fiber supply unit may include: a plurality of creels on which the reinforcing fiber is wound; an unwinding roller unwinding the reinforcing fiber from the creels, and provided adjacent to the pair of rollers of the film formation unit so that the unwinding roller brings the film-shaped resin supplied from the film formation unit into contact with the reinforcing fiber unwound from the creels; and a winding roller spaced apart from the unwinding roller at a front of the unwinding roller on the basis of a direction discharging the resin, and winding the resin-impregnated reinforcing fiber.

The fiber supply unit may further include: a compression roller spaced apart from an upper side of the unwinding roller, the compression roller rotating in the same direction as the winding roller and compressing the resin-impregnated reinforcing fiber while the resin-impregnated reinforcing fiber passes between the unwinding roller and the compression roller.

The pair of rollers of the film formation unit may include a first roller and a second roller provided above the first roller at a location spaced apart from the first roller, and rotating shafts of the first roller, the second roller, the unwinding roller, the winding roller, and the compression roller may be placed to be parallel with each other, wherein the unwinding roller may rotate in the same direction as the first roller, and may be placed adjacent to a front of the first roller on the basis of the direction discharging the resin, such that the film-shaped resin supplied from the first and second rollers is brought into contact with the reinforcing fiber passing over the unwinding roller.

The unwinding roller and the winding roller may be provided with a heating means so that the film-shaped resin passing between the unwinding roller and the winding roller is maintained at the predetermined viscosity.

A supply part of the resin supply unit that supplies the resin may be provided with a valve for controlling a feed rate of the resin, and the pair of rollers of the film formation unit may be configured such that a distance therebetween is adjusted, and the apparatus may further include: a sensing unit sensing a height of a liquid surface level of the resin contained in the film formation unit; and a control unit controlling the feed rate of the resin by comparing the height of the liquid surface level of the resin sensed by the sensing unit with a preset value and by controlling an opening ratio of the valve in accordance with a comparison result, or controlling a discharge rate of the film-shaped resin by adjusting the distance between the pair of rollers spaced apart from each other.

A method of preparing a resin-impregnated reinforcing fiber according to embodiments of the present invention includes: supplying a resin having a predetermined viscosity; forming the resin into a by passing the resin between a pair of rollers; and impregnating the resin into a reinforcing fiber by unwinding the reinforcing fiber and bringing the reinforcing fiber into contact with the film-shaped resin, and winding the resin-impregnated reinforcing fiber.

A curing agent may be added to the resin, and may be mixed with the resin in the supplying of the resin so that the curing agent is dispersed in the resin, whereby the resin is maintained at the predetermined viscosity.

In the supplying of the resin, the viscosity of the resin may be adjusted in a range of 2000 to 3000 cps.

According to the resin impregnation apparatus with the above-described configuration, since the film-shaped resin having high interfacial adhesion is impregnated into the reinforcing fiber by being brought into contact with the reinforcing fiber, it is possible to improve impregnation of the resin into the reinforcing fiber, and thus improve quality of manufactured products.

In addition, it is possible to minimize generation of excess resin and thus minimize pollution of equipment and generation of volatile organic compounds (VOC).

### BRIEF DESCRIPTION OF THE DRAWINGS

Features and other advantages of the present invention will be more clearly understood from the following detailed description when taken in conjunction with the accompanying drawings, in which:

FIG. 1 is a view showing a resin impregnation apparatus in the related art;

FIG. 2 is a view showing a resin impregnation apparatus in the related art;

FIG. 3 is a view showing a resin impregnation apparatus according to an embodiment of the present invention;

FIG. 4 is a view showing a creel, an unwinding roller, and a compression roller according to an embodiment of the present invention;

FIG. 5 is a view showing a pair of rollers, the unwinding roller, and the compression roller according to an embodiment of the present invention; and

FIG. 6 is a view showing a resin impregnation apparatus according to an embodiment of the present invention.

### DETAILED DESCRIPTION OF THE INVENTION

Embodiments of the present invention will be described in detail with reference to the accompanying drawings. Throughout the drawings, the same reference numerals will refer to the same or like parts.

An aspect of the present invention provides a system for producing a resin substrate having reinforcing fibers, or fibers (or fiber matrix) with impregnated resin.

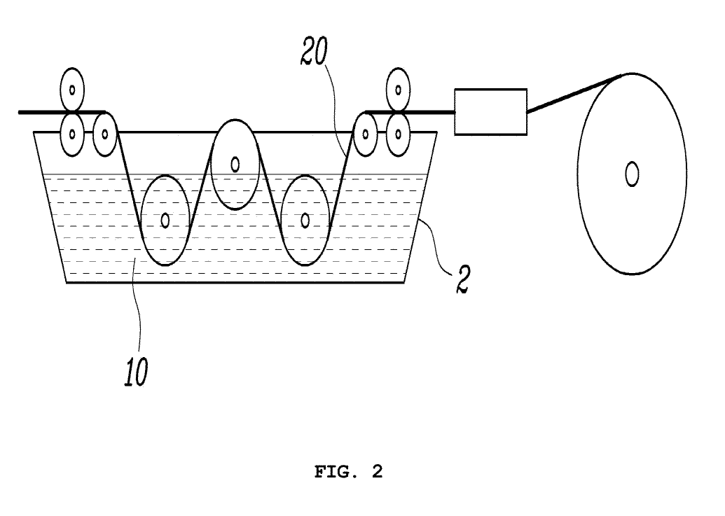

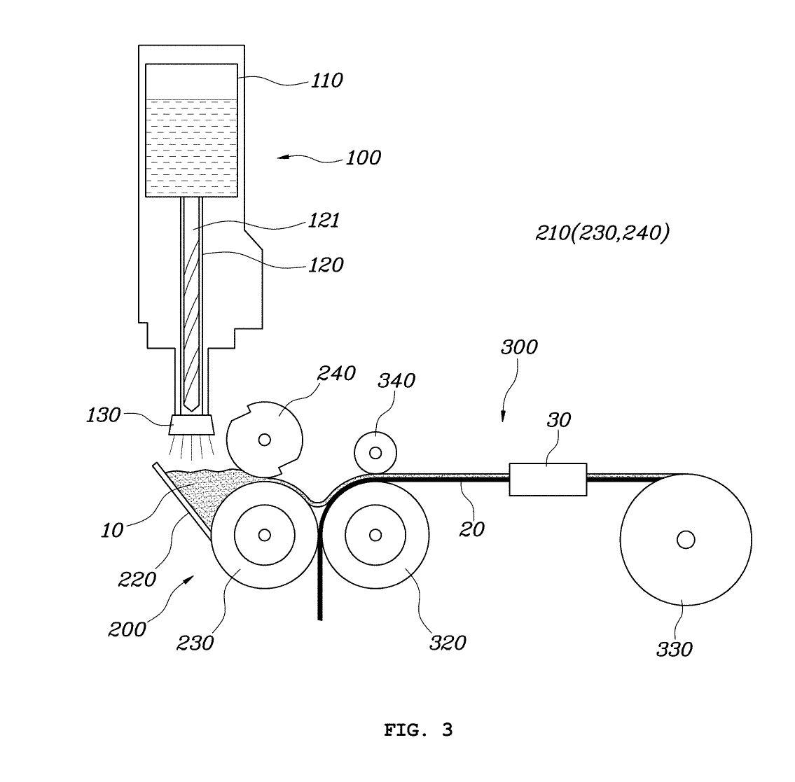

As illustrated in FIGS. 3, 5 and 6, resin 10 passes through a gap between a first roller 230 and a second roller 240 to form a resin layer (film). As the first roller operates, the resin layer passed the gap moves downward along the outer circumference of the first roller 230 in a form of film with a regulated thickness of d. In embodiments, thickness of the resin layer (d) is regulated by the gap between the first and second rollers 230, 240. In contrast, the system of FIG. 2 does not provide a resin layer of a regulated thickness. Instead, in FIG. 2, the fiber 20 is submerged in the resin container 20.

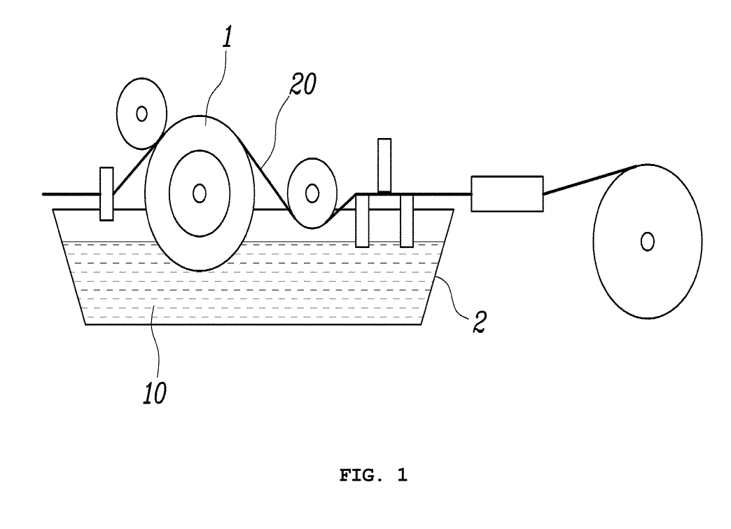

Subsequently, the resin layer is separated from the first roller 230 and transferred to (over) the fiber 20 (a layer of fiber). In contrast, in the system of FIG. 1, resin 10 transferred from container 2 by drum 1 (roller) remain on the same drum 1 until it meets the fiber. In embodiments, in a steady-state of the resin substrate production process (resin impregnation process), the resin layer maintains a constant (substantially constant, for example, with no change over 1, 2, 3, 5 or 10%) speed before and after it is transfer to the fiber 20 (when moving along the circumference of the first roller 230 and when moving along the circumference of the unwinding roller 320).

In embodiments, the first roller 230 for transferring the resin layer and the unwinding roller 320 for transferring the fiber has the same diameter and operates at the same rotational speed such that the resin layer maintains the same speed along the outer circumference of the first roller 230 and along the outer circumference of the unwinding roller 320.

In embodiments, in a steady-state of the resin substrate production process, the resin layer does not pass through the gap between the first roller 230 (for supplying the resin layer) and the unwinding roller 320 (for supplying the fiber 20). Rather, the fiber 20 and the resin place over the fiber 20 in combination pass through a gap between the compression roller 340 and the unwinding roller 320. The gap between the compression roller 340 and the unwinding roller 320 is less than the sum of the thickness of the fiber 20 and the regulated thinness d of the resin layer (film) for promoting impregnation of the resin 10 into the fiber 20.

With reference to FIG. 3, a resin impregnation apparatus according to embodiments of the present invention includes: a resin supply unit 100 supplying a resin 10 having a predetermined viscosity downwards; a film formation unit 200 provided at a lower side of the resin supply unit 100, configured to form the resin 10 supplied from the resin supply unit 100 into a film shape while the resin 10 passes between a pair of rollers 210 spaced apart from each other; and a fiber supply unit 300 unwinding a reinforcing fiber 20 and bringing the reinforcing fiber 20 into contact with the film-shaped resin 10 so that the resin 20 is impregnated into the reinforcing fiber 20, and winding the resin-impregnated reinforcing fiber 20.

The resin supply unit 100 functions to supply the resin 10 having the predetermined viscosity downwards. Here, the predetermined viscosity may be a viscosity at which, when the resin 10 having liquidity passes between the pair of rollers 210 spaced apart from each other by a distance d, the resin 10 is capable of being formed into the film-shaped resin 10 having a thickness the same as the distance d, and of being maintained in the film shape.

The resin 10 may consist of a thermosetting resin such as polyurethane (PU), a phenolic resin, an epoxy resin, etc., wherein the resin 10 may have the predetermined viscosity in a range of 2000 to 300 cps. The resin 10 may contain the thermosetting resin as a main component, and a curing agent may be added thereto.

The film formation unit 200 is provided at the lower side of the resin supply unit 100 and functions to receive the resin 10 having the predetermined viscosity from the resin supply unit 100, to form the resin 10 into the film-shape resin 10, and to discharge the film-shaped resin 10. Specifically explained, the film formation unit 200 temporarily contains the resin 10 supplied from the resin supply unit 100 and forms the resin 10 into the film-shaped resin 10 while the resin 10 passes between the pair of rollers 210. Then, the film formation unit 200 discharges the film-shaped resin 10 to the fiber supply unit 300 to be described later.

The film formation unit 200 may be provided with an opening at a position opposite to an outlet through which the resin 10 is discharged from the resin supply unit 100, so that the resin 10 having the predetermined viscosity supplied from the resin supply unit 100 is received in the film formation unit 200 through the opening. In addition, the pair of the rollers 210 of the film formation unit 200 is spaced apart from each other so that the film-shaped resin 10 is discharged therefrom. In other words, the film formation unit 200 may be open at two sides.

The fiber supply unit 300 is composed of a plurality of rollers such that a first roller unwinds the reinforcing fiber 20 and a second roller winds the resin-impregnated reinforcing fiber 20. The first roller unwinding the reinforcing fiber 20 may be placed adjacent to the pair of the rollers 210 of the film formation unit 200, so that the film-shaped resin 10 discharged from the film formation unit 200 can be brought into contact with the reinforcing fiber 20.

The film-shaped resin 10 comes into contact with the reinforcing fiber 20 while the reinforcing fiber 20 is unwound and wound at the fiber supply unit 300, and thus the reinforcing fiber 20 is impregnated with the resin 10, whereafter the resin-impregnated reinforcing fiber 20 is wound on the second roller of the fiber supply unit 300. Here, the reinforcing fiber 20 may be composed of fibers selected from a carbon fiber, a glass fiber, an aramid fiber, and a natural fiber, but is not limited thereto.

The resin supply unit 100 may be configured such that a feed rate of the resin 10 supplied through the outlet thereof is controlled. For example, it may be controlled in a range of 20 to 100 g/s.

Thus, according to the resin impregnation apparatus of the present invention, it is expected that as compared with a conventional resin impregnation apparatus, quality of manufactured products can be improved and pollution of equipment and generation of volatile organic compounds (VOC) due to generation of excess resin 10 can be reduced. This is because the reinforcing fiber 20 is brought into contact with the film-shaped resin 10 having the predetermined viscosity in such a manner that the reinforcing fiber 20 is impregnated with the resin 10.

The resin supply unit 100 may include a chamber part 110 containing the resin 10 therein and having an outlet at a lower portion thereof; a mixing part 120 having a flow path communicating with the outlet of the chamber part 110 at a first end thereof so that the resin 10 moves downwards, and a screw installed inside the flow path; and a supply part 130 communicating with a second end of the mixing part 120, and supplying the resin 10 to the film formation unit 200.

The chamber part 110 contains the resin 10 therein and has the outlet at the lower portion thereof. The mixing part 120 is provided with the flow path communicating with the outlet of the chamber part 110 and the screw installed inside the flow path. Here, the resin 10 discharged through the outlet of the chamber part 110 moves downwards via the flow path. In this process, the curing agent, which may be added to the resin 10, is dispersed uniformly in the resin 10 in accordance with operation of the screw, so that the resin 10 can be maintained at the predetermined viscosity.

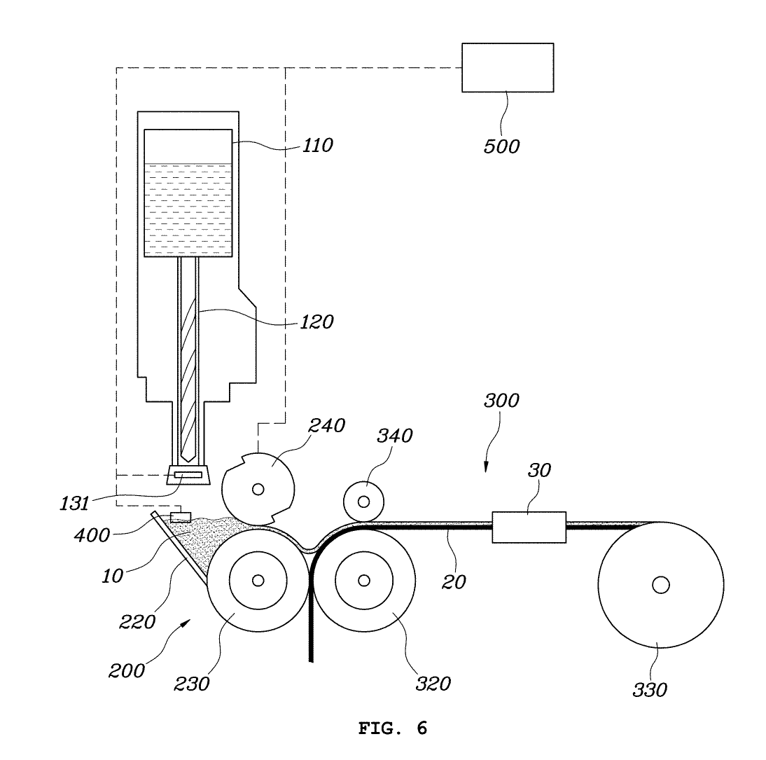

The supply part 130 communicates with the flow path and serves to supply the resin 10 to the film formation unit 200. The supply part 130 may be provided with a valve (see FIG. 6) such that the feed rate of the resin 10 with respect to the film formation unit 200 can be controlled.

The chamber part 110 may be provided such that a high pressure is famed in the inner space thereof, and so as to remove bubbles present in the resin 10. The mixing part 120 may be provided such that the resin 10 from which bubbles are removed by operation of the screw is maintained at the predetermined viscosity.

Accordingly, the chamber part 110 is provided so as to form a high pressure atmosphere therein, whereby bubbles present in the resin 10 contained in the chamber part 110 can be removed. Thus, it is possible to improve quality of manufactured products. The mixing part 120 enables the curing agent added to the resin 10 to be dispersed in the resin 10 so that the resin 10 can be maintained at the predetermined viscosity.

The film formation unit 200 may include an accommodation part 220 provided at a lower side of the resin supply unit 100 and having an opening open upward, and a containing space communicating with the opening such that the resin 10 supplied from the resin supply unit 100 is received in the accommodation part 220, the accommodation part 220 being open at a side thereof to discharge the resin 10; a first roller 230 provided at the side of the accommodation part 220 to divide the accommodation part; and a second roller 240 provided above the first roller 230 at a location spaced apart from the first roller 230 so that the film-shaped resin 10 is discharged therefrom.

The accommodation part 220 may be provided into a container shape in which the resin 10 supplied from the resin supply unit 100 is temporarily contained in the containing space formed therein. In the case that the accommodation part 220 is provided at the lower side of the resin supply unit 100 and the resin supply unit 100 includes the chamber part 110, the mixing part 120, and the supply part 130 as described above, the opening of the accommodation part 110 may be located directly below the outlet through which the resin is supplied from the supply part 130 of the resin supply unit 100.

Meanwhile, the accommodation part 220 is provided with the first roller 230 at the side thereof such that the containing space of the accommodation part 220 is divided. Further, the second roller 240 is provided above the first roller 230 at the location spaced apart from the first roller 230 to define a gap through which the film-shaped resin 10 is discharged. The resin 10 contained in the accommodation part 220 is formed into the film-shaped resin 10 while passing between the first and second rollers 230 and 240 spaced apart from each other, and then the film-shaped resin 10 is discharged.

A rotating shaft 231 of the first roller 230 may be placed to be parallel to the ground surface, and a rotating shaft 241 of the second roller 240 may be placed to be parallel to the rotating shaft 231 of the first roller 230, wherein the rotating shaft 241 of the second roller 240 may be movable up and down so that a distance d between the first and second rollers 230 and 240 is adjusted, and the resin 10 passing between the first and second rollers 230 and 240 spaced apart from each other may be formed into the film-shaped resin 10 having a thickness corresponding to the distance d between the first and second rollers 230 and 240.

The rotating shaft 231 of the first roller 230 provided at the side of the accommodation part 220 is placed to be parallel to the ground surface. The rotating shaft 241 of the second roller 240 is placed above the rotating shaft 231 of the first roller 230 to be parallel to the rotating shaft 231 of the first roller 230.

Here, the rotating shaft 241 of the second roller 240 has rails at both sides thereof, thereby being capable of moving up and down along the rails. Since the thickness of the resin 10 passing between the first and second rollers 230 and 240 spaced apart from each other corresponds to the distance d between the first and second rollers 230 and 240, the distance d may be varied in accordance with upward and downward movement of the rotating shaft 241 of the second roller 240, and accordingly the thickness of the film-shaped resin 10 may be varied.

When a liquid surface level of the resin 10 contained in the accommodation part 220 reaches a height of the gap defined by the distance d between the first and second rollers 230 and 240, the film-shaped resin 10 may be discharged from the first and second rollers 230 and 240 that rotate in opposite directions to each other.

When the liquid surface level of the resin 10, which is supplied from the resin supply unit 100 through the opening of the film formation unit 200 and contained in the containing space of the accommodation part 220, reaches the height of the gap defined by the distance between the first and second rollers 230 and 240, the first and second rollers 230 and 240 rotate so that the resin 10 passing between the first and second rollers 230 and 240 spaced apart from each other can be discharged in the form of the film-shaped resin 10. At this time, the first and second rollers 230 and 240 rotate in opposite directions to each other so that the film-shaped resin 10 can be discharged.

The first and second rollers 230 and 240 may be provided with a heating means such that the resin 10 passing between the first and second rollers 230 and 240 spaced apart from each other is maintained at the predetermined viscosity.

The first and second rollers 230 and 240 have a heat generating function, thereby heating up to a predetermined temperature so that heat generated in the first and second rollers 230 and 240 is transferred to the resin 10 passing between the first and second rollers 230 and 240 spaced apart from each other. As a result, the resin 10 can maintain the predetermined viscosity and interface adhesion without curing. Thus, the resin 10 can be efficiently impregnated into the reinforcing fiber 20 unwound at the fiber supply unit 300 by being brought into contact with the reinforcing fiber 20.

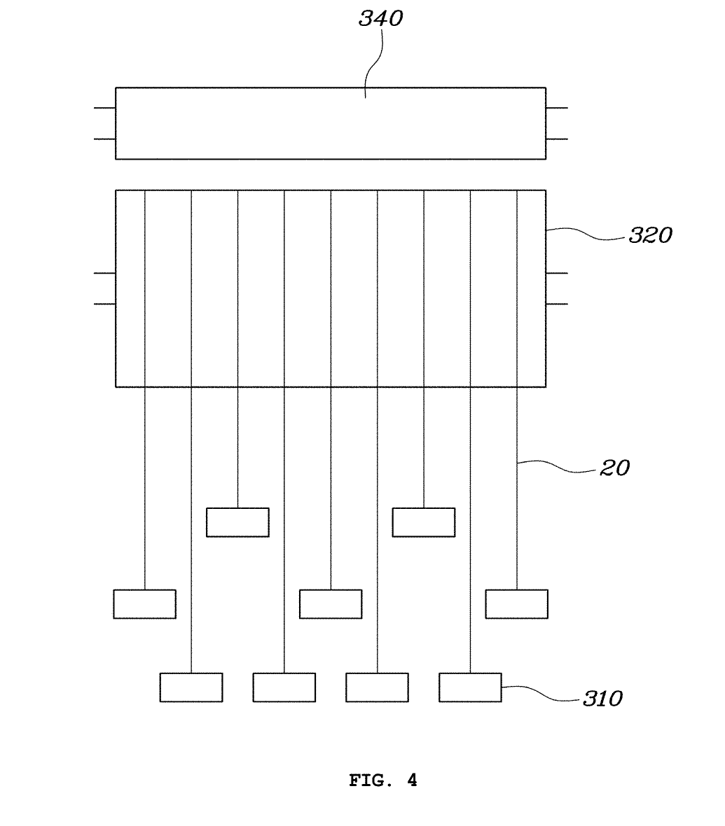

With reference to FIG. 4, the fiber supply unit 300 may include a plurality of creels 310 on which the reinforcing fiber 20 is wound; an unwinding roller 320 unwinding the reinforcing fiber 20 from the creels 310, and provided adjacent to the pair of rollers 210 of the film formation unit 200 so that the unwinding roller 320 brings the film-shaped resin 10 supplied from the film formation unit 200 into contact with the reinforcing fiber 20 unwound from the creels 310; and a winding roller 330 spaced apart from the unwinding roller 320 at a front of the unwinding roller 320 on the basis of a direction discharging the resin 10, and winding the resin-impregnated reinforcing fiber 20.

Each of the creels 310 has the reinforcing fiber 20 wound thereon and is provided in plural so that the plurality of creels 310 supplies a plurality of strands of the reinforcing fibers 20. The unwinding roller 320 is provided at an upper side of the creels 310 and unwinds the reinforcing fibers 20 from the creels 310. Here, the unwinding roller 320 is provided adjacent to the pair of rollers 210 of the film formation unit 200 so that the film-shaped resin 10 discharged from the pair of rollers 210 is brought into contact with the reinforcing fiber 20 passing over the unwinding roller 320.

When the film formation unit 200 includes the first and second rollers 230 and 240, the unwinding roller 320 may be provided adjacent to the first roller 230 to face the first roller 230 at a front of the first roller 230 on the basis of the direction discharging the resin 10. Thus, the film-shaped resin 10 passing through the distance d between the first and second rollers 230 and 240 can be brought into contact with the reinforcing fiber 20 passing over the unwinding roller 320.

The winding roller 330 is provided to be spaced apart from the unwinding roller 320 at the front of the unwinding roller 320 on the basis of the direction discharging the resin 10, such that the reinforcing fiber 20 impregnated with the resin 10 while passing over the unwinding roller 320 can wound on the winding roller 330.

A placement unit 30 may be provided between the unwinding roller 320 and the winding roller 330 so that an arrangement direction of the reinforcing fiber 20 impregnated with the resin 10 can be adjusted.

The fiber supply unit 300 may further include a compression roller 340 spaced apart from an upper side of the unwinding roller 320, the compression roller 340 rotating in the same direction as the winding roller 330 and compressing the resin-impregnated reinforcing fiber 20 while the resin-impregnated reinforcing fiber 20 passes between the unwinding roller 320 and the compression roller 340.

The compression roller 340 is spaced apart from the upper side of the unwinding roller 320 and compresses resin-impregnated reinforcing fiber 20 while the resin-impregnated reinforcing fiber 20 passes between the unwinding roller 320 and the compression roller 340, whereby impregnation of the resin 10 into the reinforcing fiber 20 can be increased and thus quality of manufactured products can be improved.

Rotating shafts 321 and 341 of the unwinding roller 320 and the compression roller 340 may be placed to be parallel with each other, and the unwinding roller 320 and the compression roller 340 may rotate in the same direction so that the reinforcing fiber 20 can be compressed while moving forward.

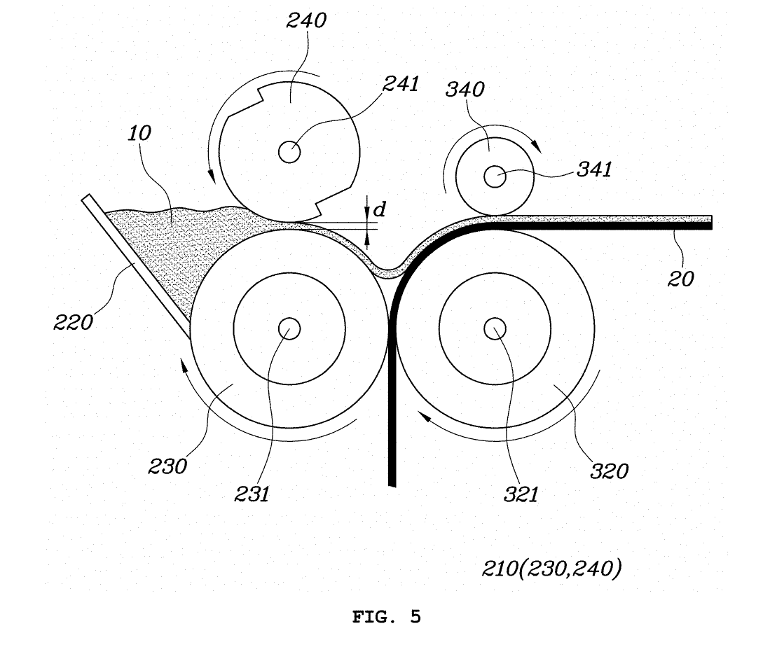

With reference to FIG. 5, the pair of rollers 210 of the film formation unit 200 may include the first roller 230 and the second roller 240 provided above the first roller 230 at the location spaced apart from the first roller 230, and rotating shafts the first roller 230, the second roller 240, the unwinding roller 320, the winding roller 330, and the compression roller 340 may be placed to be parallel with each other, wherein the unwinding roller 320 rotates in the same direction as the first roller 230, and is placed adjacent to the front of the first roller 230 on the basis of the direction discharging the resin 10, such that the film-shaped resin 10 discharged from the first and second rollers 230 and 240 can be brought into contact with the reinforcing fiber 20 passing over the unwinding roller 320.

The resin 10 contained in the film formation unit 200 is discharged in the form of the film-shaped resin 10 by the first roller 230 and the second roller 240 provided above the first roller 230 at the location spaced apart from the first roller 230. Here, rotating shafts of the first roller 230, second roller 240, the unwinding roller 320, and the winding roller 330 are placed to be parallel with each other, and the unwinding roller 320 is placed adjacent to the front of the first roller 230 on the basis of the direction discharging the resin 10. Accordingly, the resin 10 discharged in the form of the film-shaped resin 10 can be brought into contact with the reinforcing fiber 20 passing over the unwinding roller 320 and thus can be impregnated into the reinforcing fiber 20.

The unwinding roller 320 and the winding roller 330 may be provided with a heating means so that the film-shaped resin 10 passing between the unwinding roller 320 and the winding roller 330 can be maintained at the predetermined viscosity.

The unwinding roller 320 and the winding roller 330 may have a heat generating function, thereby heating up to a predetermined temperature. Heat of the unwinding roller 320 and the winding roller 330 is transferred to the resin 10 that is in the process of being impregnated into the reinforcing fiber 20 while passing over the unwinding roller 320 and the winding roller 330. As a result, the resin 10 can be maintained at the predetermined viscosity without curing.

With reference to FIG. 6, the supply part 130 of the resin supply unit 100 that supplies the resin 10 may be provided with a valve 131 for controlling the feed rate of the resin 10, and the pair of rollers 210 of the film formation unit 200 may be configured such that a distance therebetween can be adjusted.

In addition, the resin impregnation apparatus according to embodiments of the present invention may further include: a sensing unit 400 sensing a height of the liquid surface level of the resin 10 contained in the film formation unit 200; a control unit 500 controlling the feed rate of the resin 10 by comparing the height of the liquid surface level of the resin 10 sensed by the sensing unit 400 with a preset value and by controlling an opening ratio of the valve in accordance with a comparison result, or controlling a discharge rate of the film-shaped resin 10 by adjusting the distance d between the pair of rollers 210 spaced apart from each other.

As mentioned above, the resin 10 contained in the film formation unit 200 can be maintained in a desired amount, whereby generation of excess resin 10 can be minimized.

The film formation unit 200 is provided with the sensing unit 400 sensing the height of the liquid surface level of the resin 10 contained in the film formation unit 200 using a float.

The control unit 500 functions to control the feed rate of the resin 10 by comparing the height of the liquid surface level of the resin 10 sensed by the sensing unit 400 with the preset value and by controlling the opening ratio of the valve provided at the supply part 130 of the resin supply unit 100, or control the discharge rate of the film-shaped resin 10 by adjusting the distance d between the pair of rollers 210 spaced apart from each other.

Here, the preset value is a value that may be arbitrarily set, and may indicate a height of a liquid surface level of the resin 10 to such an extent that the resin 10 does not overflow.

The amount of resin 10 temporarily contained in the film formation unit 200 may be determined by subtracting the amount of the resin 10 discharged in the form of the film-shaped resin 10 from the amount of the resin 10 supplied per unit time.

For example, when a sensed value is higher than the preset value, the valve is closed so as to reduce the feed rate of the resin 10, or the distance d between the pair of rollers 210 is increased so as to increase the discharge rate of the film-shaped resin 10.

On the other hand, when the sensed value is lower than the preset value, the valve is opened so as to increase the feed rate of the resin 10, or the distance d between the pair of rollers 210 is reduced so as to reduce the discharge rate of the film-shaped resin 10.

A method of preparing a resin-impregnated fiber according to embodiments of the present invention includes: supplying a resin 10 having a predetermined viscosity; forming the resin 10 into a film-shape resin by passing the resin 10 between a pair of rollers 210; and impregnating the resin 10 into a reinforcing fiber 20 by unwinding the reinforcing fiber 20 and bringing the reinforcing fiber 20 into contact with the film-shaped resin 10, and winding the resin-impregnated reinforcing fiber 20.

A curing agent may be added to the resin 10, and may be mixed with the resin 10 in the supplying of the resin 10 so that the curing agent is dispersed in the resin 10, whereby the resin 10 can be maintained at the predetermined viscosity.

In the supplying of the resin 10, the viscosity of the resin 10 may be adjusted in a range of 2000 to 3000 cps.

In the supplying the resin 10, the resin 10 having the predetermined viscosity is supplied. Here, the predetermined viscosity may be a viscosity at which, when the resin 10 having liquidity passes between the pair of rollers 210 spaced apart from each other by a distance d, the resin 10 is capable of being formed into the film-shaped resin 10 having a thickness the same as the distance d, and of being maintained in the film shape. The resin 10 may be made of a thermosetting resin such as polyurethane (PU), a phenol resin, an epoxy resin, etc., wherein the predetermined viscosity of the resin 10 may be in a range of about 2000 to 3000 cps.

In the forming of the resin 10 into the film-shaped resin, the resin 10 having the predetermined viscosity is formed into the film-shaped resin 10 while passing between the pair of rollers 210 spaced apart from each other. In the impregnating of the resin 10 into the reinforcing fiber 20, the reinforcing fiber 20 is unwound and brought into contact with the film-shaped resin 10 in such a manner as to be impregnated with the resin 10, and thus the obtained resin-impregnated reinforcing fiber 20 is wound.

Here, the reinforcing fiber 20 may be composed of fibers selected from a carbon fiber, a glass fiber, an aramid fiber, and a natural fiber, but is not limited thereto.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A resin impregnation apparatus, comprising:
a resin supply unit supplying a resin having a predetermined viscosity downwards;
a film formation unit provided at a lower side of the resin supply unit, configured to form the resin supplied from the resin supply unit into a film shape while the resin passes between a pair of rollers spaced apart from each other; and
a fiber supply unit unwinding a reinforcing fiber and bringing the reinforcing fiber into contact with the film-shaped resin so that the resin is impregnated into the reinforcing fiber, and winding the resin-impregnated reinforcing fiber.

2. The resin impregnation apparatus of claim 1, wherein the resin supply unit includes:
a chamber part containing the resin in an inner space thereof and having an outlet at a lower portion thereof;
a mixing part having a flow path communicating with the outlet of the chamber part, at a first end thereof so that the resin moves downwards, and having a screw installed inside the flow path; and
a supply part communicating with a second end of the mixing part, and supplying the resin to the film formation unit.

3. The resin impregnation apparatus of claim 2, wherein
the chamber part is provided such that a high pressure is formed in the inner space thereof so as to remove bubbles present in the resin, and
the mixing part is provided such that the resin from which bubbles are removed by operation of the screw is maintained at the predetermined viscosity.

4. The resin impregnation apparatus of claim 1, wherein the film formation unit includes:
an accommodation part provided at a lower side of the resin supply unit, and having an opening open upward and a containing space communicating with the opening such that the resin supplied from the resin supply unit is received in the accommodation part, the accommodation part being open at a side thereof to discharge the resin;
a first roller provided at a side of the accommodation part to divide the accommodation part; and
a second roller provided above the first roller at a location spaced apart from the first roller so that a film-shaped resin is discharged therefrom.

5. The resin impregnation apparatus of claim 4, wherein
a rotating shaft of the first roller is placed to be parallel to a ground surface, and a rotating shaft of the second roller is placed to be parallel to the rotating shaft of the first roller, wherein the rotating shaft of the second roller is movable up and down so that a distance between the first and second rollers can be adjusted, and
the resin passing between the first and second rollers is formed into the film-shaped resin having a thickness corresponding to the distance between the first and second rollers.

6. The resin impregnation apparatus of claim 5, wherein when a liquid surface level of the resin contained in the accommodation part reaches a height of a gap defined by the distance between the first and second rollers, the film-shaped resin is discharged from the first and second rollers that rotate in opposite directions to each other.

7. The resin impregnation apparatus of claim 4, wherein the first and second rollers are provided with a heating means such that the resin passing between the first and second rollers is maintained at the predetermined viscosity.

8. The resin impregnation apparatus of claim 1, wherein the fiber supply unit includes:
a plurality of creels on which the reinforcing fiber is wound;
an unwinding roller unwinding the reinforcing fiber from the creels, and provided adjacent to the pair of rollers of the film formation unit so that the unwinding roller brings the film-shaped resin supplied from the film formation unit into contact with the reinforcing fiber unwound from the creels; and
a winding roller spaced apart from the unwinding roller at a front of the unwinding roller on the basis of a direction discharging the resin, and winding the resin-impregnated reinforcing fiber.

9. The resin impregnation apparatus of claim 8, wherein the fiber supply unit further includes:
a compression roller spaced apart from an upper side of the unwinding roller, the compression roller rotating in the same direction as the winding roller and compressing the resin-impregnated reinforcing fiber while the resin-impregnated reinforcing fiber passes between the unwinding roller and the compression roller.

10. The resin impregnation apparatus of claim 9, wherein
the pair of rollers of the film formation unit includes a first roller and a second roller provided above the first roller at a location spaced apart from the first roller, and
rotating shafts of the first roller, the second roller, the unwinding roller, the winding roller, and the compression roller are placed to be parallel with each other,
wherein the unwinding roller rotates in the same direction as the first roller, and is placed adjacent to a front of the first roller on the basis of the direction discharging the resin, such that the film-shaped resin supplied from the first and second rollers is brought into contact with the reinforcing fiber passing over the unwinding roller.

11. The resin impregnation apparatus of claim 8, wherein the unwinding roller and the winding roller is provided with a heating means so that the film-shaped resin passing between the unwinding roller and the winding roller is maintained at the predetermined viscosity.

12. The resin impregnation apparatus of claim 1, wherein a supply part of the resin supply unit that supplies the resin is provided with a valve for controlling a feed rate of the resin, and the pair of rollers of the film formation unit is configured such that a distance therebetween can be adjusted, the apparatus further comprising:
a sensing unit sensing a height of a liquid surface level of the resin contained in the film formation unit; and
a control unit controlling the feed rate of the resin by comparing the height of the liquid surface level of the resin sensed by the sensing unit with a preset value and by controlling an opening ratio of the valve in accordance with a comparison result, or controlling a discharge rate of the film-shaped resin by adjusting the distance between the pair of rollers spaced apart from each other.

13. A method of preparing a resin-impregnated reinforcing fiber, the method comprising:
supplying a resin having a predetermined viscosity;
forming the resin into a film-shaped resin by passing the resin between a pair of rollers; and
impregnating the resin into a reinforcing fiber by unwinding the reinforcing fiber and bringing the reinforcing fiber into contact with the film-shaped resin, and winding the resin-impregnated reinforcing fiber.

14. The method of claim 13, wherein a curing agent is added to the resin, and is mixed with the resin in the supplying of the resin so that the curing agent is dispersed in the resin, whereby the resin is maintained at the predetermined viscosity.

15. The method of claim 14, wherein in the supplying of the resin, the viscosity of the resin is adjusted in a range of 2000 to 3000 cps.
